(19) United States
(12) Patent Application Publication
(10) Pub. No.: US 2014/0122704 A1
(43) Pub. Date: May 1, 2014

(54) REMOTE PORT MIRRORING

(71) Applicant: Hangzhou H3C Technologies Co., Ltd., Hangzhou (CN)

(72) Inventor: Jiabing Wang, Beijing (CN)

(73) Assignee: Hangzhou H3C Technologies Co., Ltd., Hangzhou (CN)

(21) Appl. No.: 13/965,006

(22) Filed: Aug. 12, 2013

(30) Foreign Application Priority Data
Oct. 26, 2012 (CN) 201210416102.2

(51) Int. Cl. H04L 12/931

(52) U.S. Cl. CPC H04L 49/208
USPC 709/224

(57) ABSTRACT

According to an example, remote port mirroring includes storing correspondence information describing a correspondence between a mirroring source port and a mirroring destination port. The correspondence information includes a VLAN ID of a mirror VLAN. The mirroring source port and the mirroring destination port are assigned to the mirror VLAN. A message received on the mirroring source port is copied, and a mirroring message is generated based on the correspondence information and sent to the remote network switch.

### BACKGROUND

Port mirroring can be used to monitor network traffic and typically includes sending a copy of incoming and/or outgoing network packets seen on one switch port or an entire virtual local area network (VLAN) to a network monitoring connection on another switch port. A network administrator can place a network monitoring device on the port receiving the mirrored data to monitor the network traffic generally without affecting the client on the original port. For remote port monitoring, the packets are copied and sent to a port on another switch, which then forwards the mirroring message to the data monitoring device.

Layer 2 remote port mirroring is implemented through the cooperation between a remote source mirroring group and a remote destination mirroring group. A source device copies the packets passing through a mirroring port, and broadcasts the packets in the VLAN. The broadcasted packets may eventually be forwarded to a data monitoring device connected to the network.

### BRIEF DESCRIPTION OF DRAWINGS

Embodiments are described in detail in the following description with reference to examples shown in the following figures.

FIGS. 1 and 2 illustrate examples of determining correspondence information.

FIGS. 3 and 4 illustrate examples of remote packet mirroring based on correspondence information.

FIG. 5 illustrates an example of a network switch.

FIG. 6 illustrates an example of a method for remote port mirroring.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an example, remote port mirroring utilizes multicasting or unicasting in a network to mirror packets to a remote port. Remote port mirroring includes copying incoming, outgoing or both incoming and outgoing packets from a source port on a network switch to a destination port on another network switch. The destination port may be connected to a data monitoring device to analyze the mirrored packets.

The remote port mirroring may be performed in a Transparent Interconnection of Lots of Links (TRILL) network. The TRILL protocol implements concepts for a layer 3 routing technology into a layer 2 network and combines the features of simplicity and flexibility of the layer 2 network with the features of stability, extensibility and high performance of the layer 3 network. TRILL is described in Internet Engineering Task Force (IETF) standard RFC 6325, “Routing Bridges (RBridges): Base Protocol Specification” and RFC 6326, “Transparent Interconnection of Lots of Links (TRILL) Use of IS-IS.”

TRILL combines the advantages of both bridges and routers and is the application of link state routing to the VLAN-aware customer-bridging problem. The network switches implementing the TRILL protocol are referred to as routing bridges (referred to as RBs or RBridges). RBridges run a link state protocol amongst themselves. A link state protocol is one in which connectivity is broadcasted to all the RBridges, so that each RBridge knows about all the other RBridges, and the connectivity between them. This gives RBridges enough information to compute pair-wise optimal paths for unicast, and to calculate distribution trees for delivery of frames either to destinations whose location is unknown or to multicast/broadcast groups. A link state routing protocol that may be used is Intermediate System to Intermediate System (IS-IS).

For remote port mirroring, a mirroring source and mirroring destination may belong to different mirroring groups on different devices. A mirroring group for example includes one or multiple mirroring ports and may include a monitor port. These ports for example are not assigned to any other mirroring group. A mirroring group where the mirroring source is located is called a source mirroring group, and a mirroring group where the mirroring destination is located is called a destination mirroring group, and devices between the source device and the destination device are called intermediate devices.

According to an example, remote port mirroring in a TRILL network may include establishing a correspondence between a source mirroring group and a destination mirroring group. A mirrored packet may be unicasted (e.g., when the egress routing bridge is known) or multicasted on a multicast distribution tree in a TRILL network to multiple destinations based on stored correspondence information. This avoids broadcast flooding of mirroring messages in the network, which saves bandwidth. In one example, the stored correspondence information may be an entry in table stored at the network switch. Also, the remote port mirroring provides security in the network by providing for remote network traffic monitoring and analyzing using one or more data monitoring devices.

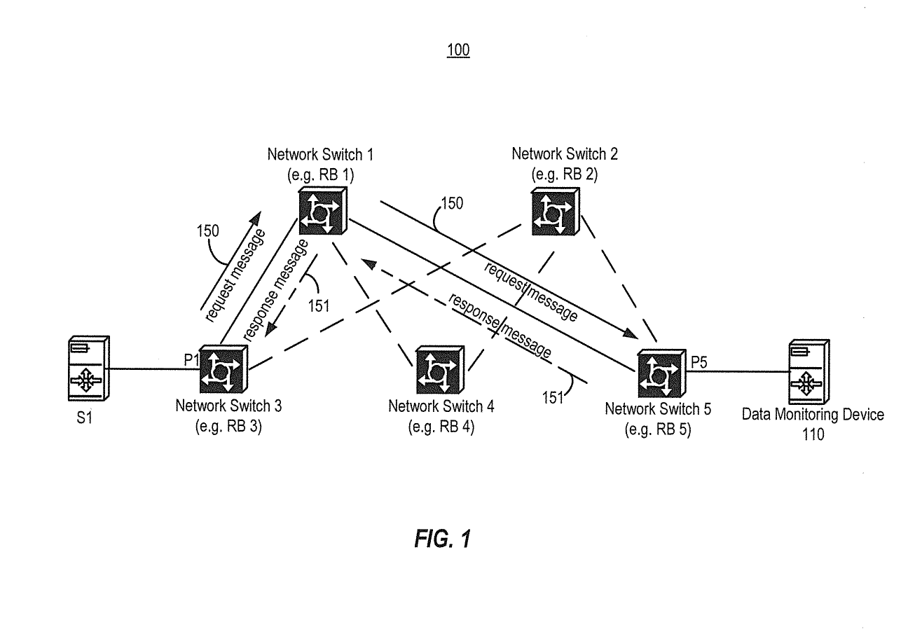

FIG. 1 shows an example of determining correspondence information for remote port mirroring. FIG. 1 includes network switches 1-5 in a network 100. The network switches may be layer 2 switches, layer 2/3 switches or layer 3 switches (e.g., routers) where the layers refer to the Open Systems Interconnection (OSI) model. The network 100 may include any number of network switches.

Network devices may be connected to the network 100 to send and receive data from other network devices. A network device is any computer that can connect to the network 100 to send and receive data. A network device may include server S1 connected to the network. A data monitoring device 110 may be connected to the network 100. The data monitoring device 110 can analyze packets. In one example, the packet analysis may be performed to detect network security threats. One example of the data monitoring device 110 is an intrusion prevention system (IPS). For remote port mirroring, the mirroring destination port may be selected based on where the data monitoring device 110 is located. For example, remote port mirroring may be performed to send packets to remote data monitoring device 110 to analyze the packets. The data monitoring device 110 may be connected to a remote network switch, so that switch and a port on that switch that is connected to the data monitoring device 110 may be selected as the mirroring destination port for remote port mirroring.

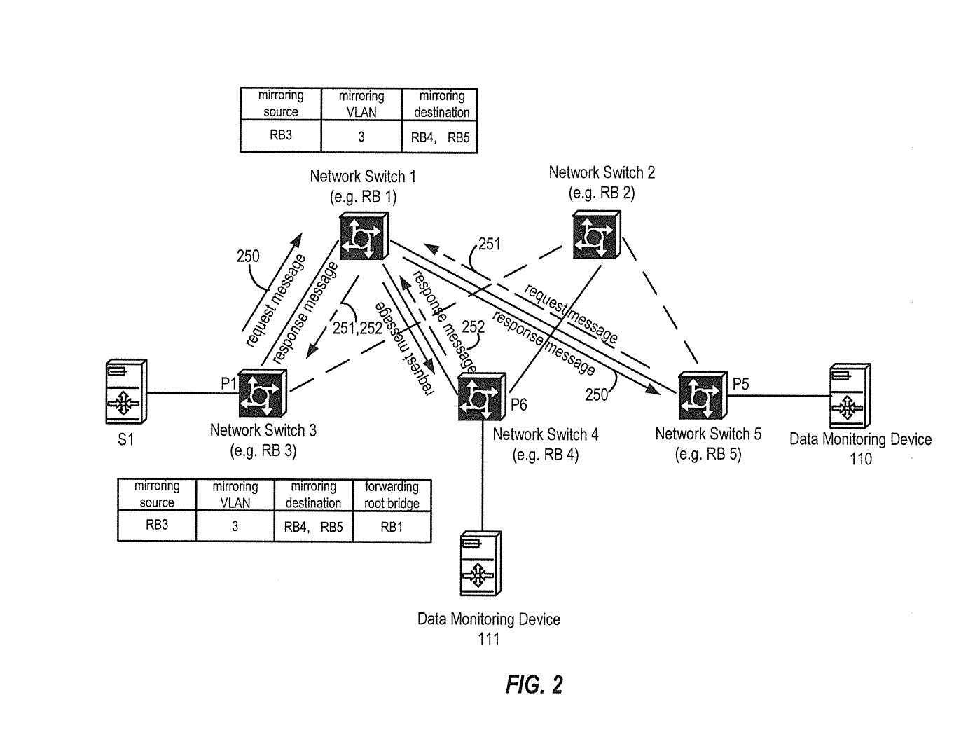

The network switches 1-5 may perform remote port mirroring. In the examples shown in FIGS. 1 and 2, network switch 3 mirrors incoming or outgoing messages, which may include packets, received on mirroring source port P1 by copying the messages and sending the messages as mirroring messages to mirroring destination port P5 on network switch 5. The network switch 3 with the mirroring source port P1 is referred to as the source network switch and the network switch 5 with the mirroring destination port P5 is referred to as the remote network switch. There may be multiple mirroring destination ports on multiple remote network switches as shown in FIG. 2. For example, network switch 4 is also a remote network switch with mirroring destination port P6.

As shown in FIG. 1, the mirroring destination port P5 may be connected to the data monitoring device 110. Mirroring messages received on the mirroring destination port P5 may be sent to the data monitoring device 110 for analysis. More than one data monitoring device may be used in the network 100. For example, FIG. 2 shows data monitoring device 111 connected to P6.

Mirrored packets may be unicasted or multicasted to their mirroring destination ports in the network 100 instead of broadcasted. Furthermore, identifying the remote network switches for the remote port mirroring can be performed without flooding the network.

In one example, the network 100 is a TRILL network and the network switches 1-5 are Rbridges, shown as RBs 1-5 in FIG. 1. RBs 1-5 implement a link state routing protocol to share link states and for routing in the network 100. In one example, the IS-IS protocol is used but other link state protocols may be used. Using the link state routing protocol, RBs 1-5 exchange node information and link information such that each of the RBs 1-5 learns the full topology of the network 100.

Each of the RBs 1-5 may store, in addition to link connectivity and link cost, information such as VLAN connectivity, root RBs for multicast distribution trees (also referred to as forwarding RBs), nicknames for RBs, etc. Each of the RBs 1-5 can independently calculate optimal point-to-point paths for unicast frames to a known destination and can determine multicast distribution trees for multicasting frames in the TRILL network. Unicast frames may be forwarded hop-by-hop toward an egress RB identified in the fame (i.e., a known destination), and multi-destination frames (e.g., broadcast or multicast) are forwarded on a multicast distribution tree rooted at an RB selected by the ingress RB.

Assuming the network 100 is a TRILL network, to mirror packets for S1, a source mirroring group is created on RB 3 including the mirroring source port P1 connected with S1. A remote destination mirroring group is created on RB5 including the mirroring destination port P5 connected to the data monitoring device 110. Also, RB 3 and RB 5 are assigned to the same VLAN, which is referred to as the mirror VLAN.

As discussed above, remote port mirroring may be performed by unicasting or multicasting a mirroring message to a mirroring destination port based on a stored correspondence information describing a correspondence or relationship between the mirroring source port and the mirroring destination port. In one example, the stored correspondence information may be an entry in a table in RB 3. FIG. 1 shows an example of how the correspondence information is determined when there is a single a mirroring destination port corresponding to the a mirroring source port.

RB 3 may generate a request to determine an identify of any RBs with a mirroring destination port. TRILL uses “nicknames” as identities, so the nicknames of the RBs with a mirroring destination port for the port P1 are determined.

RB 3 multicasts a request 150 in the network 100 to determine the identity of any RB with a corresponding mirroring destination port for P1. For example, RB 3 determines the mirror VLAN of the source mirroring group for P1. When the source mirroring group is created, the source mirroring group, including P1, may be assigned to the mirror VLAN and the mirror VLAN ID may be stored in RB3 for the source mirroring group.

RB 3 sends request 150 via a TRILL multicast distribution tree to request for the nickname of any RBs where a mirroring destination port is located. TRILL uses the distribution trees to deliver multi-destination frames. Multiple trees can be used by an ingress RB for different flows and/or multicast groups. An RB may choose different distribution trees for the same VLAN and/or multicast group traffic. An RB can compute a distribution tree based on the link state information through shortest path first calculations, so the distribution tree may include shortest paths to destinations.

RB 3 may select a distribution tree for sending the request 150. The request 150 includes the VLAN ID of the mirror VLAN. Any RB receiving the request 150 determines whether its own mirror VLAN is the same as the mirror VLAN of RB 3. If so, the RB responds with its nickname. In the example shown in FIG. 1, RB 5 has the same mirror VLAN, and returns response 151 carrying RB 5's nickname. RB 3 receives the response 151 and stores the correspondence information between the mirror VLAN, the nickname of RB 3/P1 and the nickname of RB 5. In one example, RB 3 may store a table including the nickname of RB 3 and the VLAN ID of the mirror VLAN.

FIG. 2 shows an example of how to determine the correspondence information when there are multiple mirroring destination ports corresponding to the mirroring source port P1. The sending of the request may be the same as shown in FIG. 1 but in this example there is more than one remote RB with a corresponding mirroring destination port. For example, multiple data monitoring devices, shown as 110 and 111 connected to mirroring destination ports P5 and P6 respectively may be used to analyze packets for S1. In this example, a root RB of a TRILL multicast distribution tree stores the correspondence information in addition to the source RB. For example, RB 1 is the root RB for the multicast distribution tree used by source RB 3. RB 1 stores the nickname of RB 3, the VLAN ID of the mirror VLAN and the nicknames of all the remote RBs with mirroring destination ports. FIG. 2 shows an example of a table that may be stored at the root RB 1, including mirroring source (e.g., source nickname), mirroring VLAN (e.g., mirror VLAN ID), and mirroring destination (e.g., nicknames of remote RBs with mirroring destination ports corresponding to P1). In one example, RB 3 determines the nicknames of the remote RBs with mirroring destination ports corresponding to the mirroring source port P1, and sends the information to RB 1. Also, RB 3, in addition to storing the VLAN ID of the mirror VLAN and the nicknames of all the remote RBs; also stores the nickname of the root RB 1, so RB 3 knows which RB is the root RB for the multicast distribution tree for sending mirrored packets. The root RB 1 forwards the mirrored packets, which are encapsulated in TRILL messages, to the remote RBs where mirroring destination ports are located through the multicast distribution tree.

FIG. 2 shows how the remote RBs with mirroring destination ports corresponding to P1 are determined. RB 3 sends request 250 on a multicast distribution tree to request the nicknames for the remote RBs with mirroring destination ports corresponding to P1. RB 5 determines that its mirror VLAN is the same as the mirror VLAN of RB 3 identified from the request 250 message, and RB 5 returns a response 251 carrying its nickname. Similarly, RB 4 determines that its mirror VLAN is the same as the mirror VLAN of RB 3 identified from the request 250 message, and RB 4 returns a response 252 carrying its nickname. If the mirror VLANs did not match for RB 4 or RB 5, then those RBs would not respond to the request 250. The responses 251 and 252 are received by RB 3, and RB 3 stores the nicknames of RB 4 and RB 5 in the correspondence information, which is shown in FIG. 2 and described above. Root RB 1 also stores correspondence information, which is shown in FIG. 2 and described above.

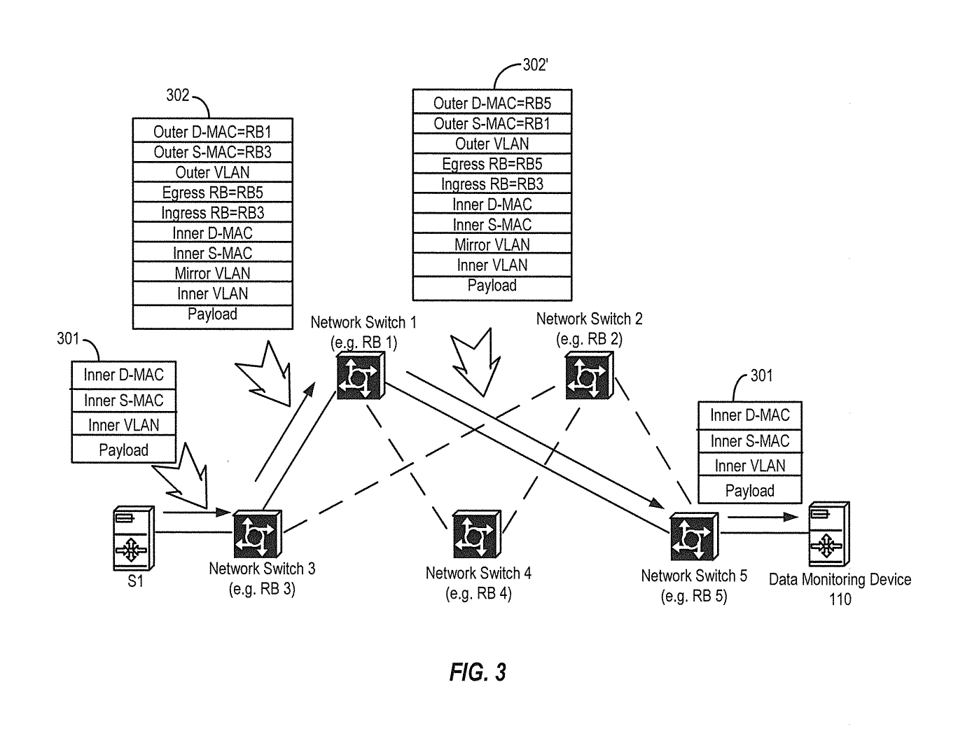

After the correspondence information between the mirroring source port and the one or more mirroring destination ports is determined, the source RB can send copies of incoming or outgoing packets for the mirroring source port to the one or more mirroring destination ports to perform remote port mirroring. FIG. 3 relates to the example in FIG. 1 where there is a single mirroring destination port, and the source RB 3 stores the correspondence information between source RB 3 having mirroring source port P1 and remote RB 5 having mirroring destination port P5.

In FIG. 3, incoming and outgoing packets for S1 are to be monitored by the data monitoring device 110. A remote source mirroring group is created on RB3 and a remote destination mirroring group is created on RB 5 with the same mirror VLAN. RB 3 receives a message 301 on mirroring source port P1. For example, the message may be a packet from S1 with a payload and a header. The header may include fields such as inner D-MAC, inner S-MAC, and inner VLAN. Upon receiving the message 301 on the mirroring source port P1, RB 3 determines, from a table of stored correspondence information, a nickname of RB 5 where the mirroring destination port P5 is located, and copies and encapsulates the copied message into a TRILL mirroring message 302. For example, RB 3 performs the following: RB 3 labels the message 301 with the mirror VLAN ID (e.g., VLAN tag of the Mirror VLAN); performs a lookup in a stored table with the mirror VLAN ID for the mirroring source port P1; determines the nickname of RB 5 from the results; and generates the TRILL mirroring message 302 with a TRILL header. The TRILL mirroring message 303 includes the nickname of the ingress RB, which is the nickname of RB 3, the nickname of the egress RB, which is the nickname of RB 5, an outer VLAN, which is used for forwarding in the TRILL network 100, and an outerlayer Ethernet header, such as the destination MAC of the next hop RB 1, and the source MAC of RB 3, so as to encapsulate the message 301 into TRILL mirroring message 302. Other conventional fields of the message 301 may also be included in the TRILL mirroring message 302 but are not shown.

RB3 sends the TRILL mirroring message 302 to RB5 for example through a TRILL unicast distribution tree. For example, intermediate RB5 between RB 3 and RB 5 in the TRILL unicast distribution tree forward the TRILL mirroring message 302 hop-by-hop in accordance with the egress RB nickname in the TRILL mirroring message 302 until the TRILL mirroring message 302 is received at RB 5. For example, at RB 1, TRILL mirroring message 302 is modified to include the next hop in the outerlayer Ethernet header, such as RB 5 for the destination MAC which is shown as TRILL mirroring message 302′. RB 5 de-encapsulates the received TRILL message 302′ and restores it into the original message 301 in order to be sent to the data monitoring device 110 from the mirroring destination port P5.

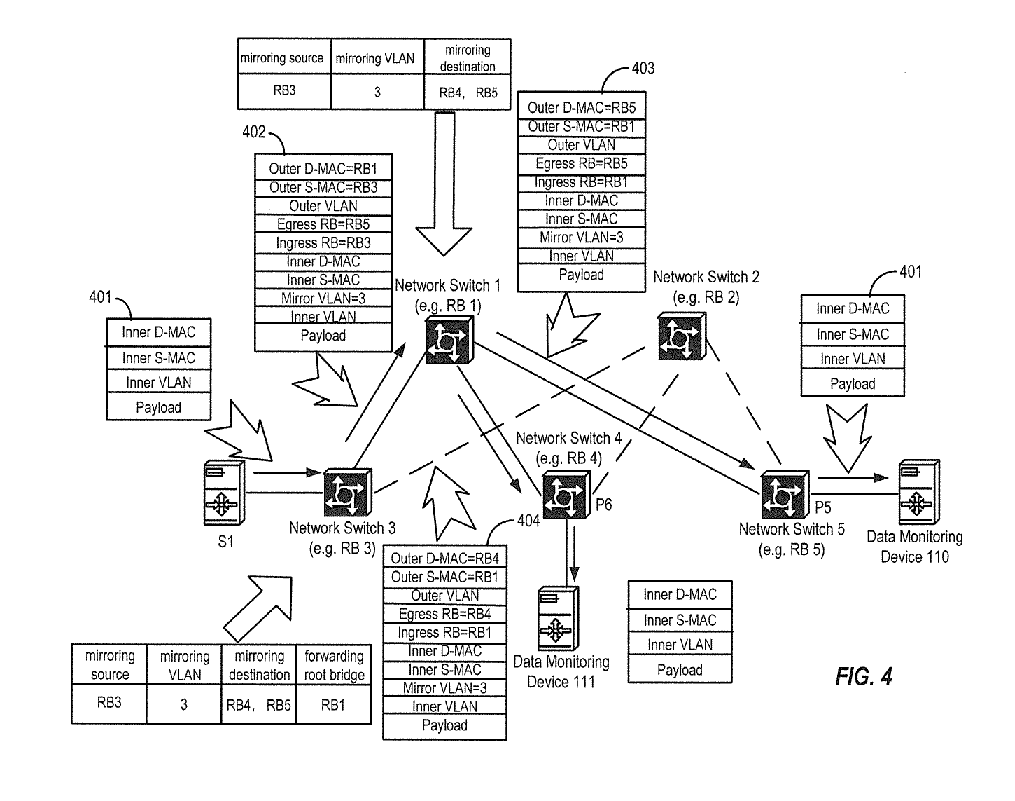

FIG. 4 shows an example of remote port mirroring to multiple mirroring destination ports P5 and P6 corresponding to a mirroring source port P1. FIG. 4 relates to the example in FIG. 2.

In FIG. 4, incoming and outgoing packets for S1 are to be monitored by the data monitoring devices 110 and 111. A remote source mirroring group is created on RB 3 and remote destination mirroring groups are created on RB 5 and RB 4 with the same mirror VLAN. RB 3 receives a message 401 on mirroring source port P1. For example, the message may be a packet from S1 with a payload and a header. The header may include fields such as inner D-MAC, inner S-MAC, and inner VLAN.

Upon receiving the message 401 on the mirroring source port P1, RB 3 determines, from a table of stored correspondence information, that multiple mirroring destination ports are associated with the mirroring source group. For example, a lookup is performed with mirror VLAN ID which identifies the nicknames of RB 4 and RB 5 where the mirroring destination ports are located. From the lookup, the nickname of the root RB 1 is determined.

RB 3 copies the message 401 and encapsulates the message 401 into a TRILL mirroring message 402. The TRILL mirroring message 402 may include the mirror VLAN ID and a TRILL header. Examples of the fields are shown at 402. RB3 sends the TRILL mirroring message 402 to root RB 1.

Upon receiving the TRILL message 402, RB 1 performs a lookup in a table of correspondence information for example using the mirror VLAN ID and the ingress RB nickname which are in the TRILL mirroring message 402. From the lookup, RB 1 identifies the nicknames of RB 4 and RB 4 including mirroring destination ports. RB 1 de-encapsulates TRILL mirroring message 402 and re-encapsulates the message 401 into a TRILL mirroring message for each destination. TRILL mirroring message 403 is generated for RB 4 and TRILL mirroring message 404 is generated for RB 4. RB 1 sends the TRILL mirroring messages 403 and 404 to their destinations through a TRILL multicast distribution tree. RB4 and RB4 de-encapsulate the received TRILL messages and restore them it to the original message 401 in order to send to the data monitoring devices 110 and 111.

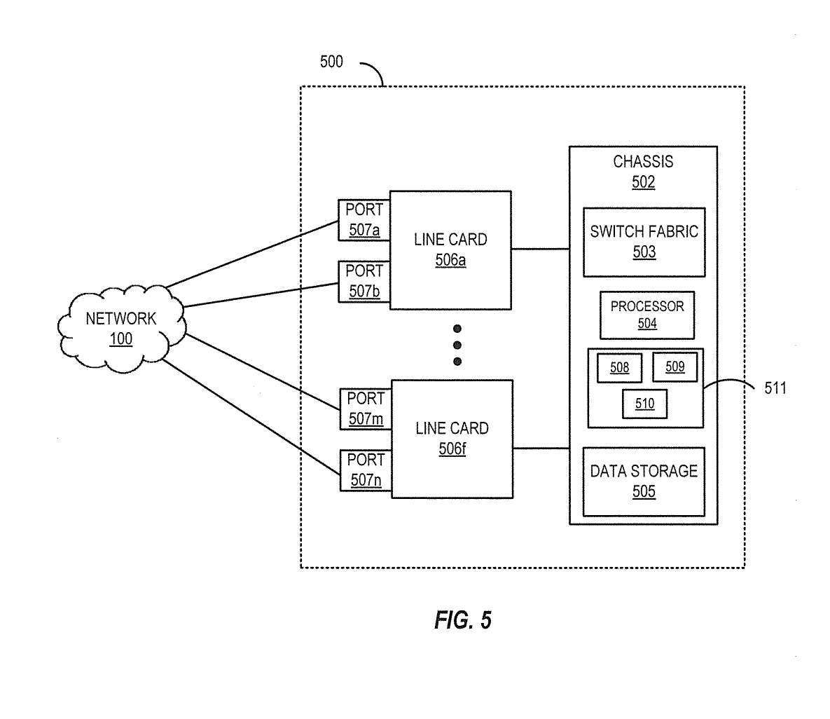

FIG. 5 illustrates an example of a network switch 500 that may be used for any of the network switches shown in FIGS. 1-4. The network switch 500 may perform the methods and functions described herein. The network switch 500 may include additional components not shown or some of the components may be removed and/or modified.

The network switch 500 includes ports 507a-n. The ports 507a-n are configured to receive and send packets in the network 100. The network switch 500 also includes a chassis 502. The chassis 502 includes switch fabric 503, a processor 504, data storage 505, and line cards 506a-f. The switch fabric 503 may include a high-speed transmission medium for routing packets between the ports 507a-n internally in the network switch 500. The line cards 506a-f may store routing and link state information and other information described herein. The line cards 506a-f may also control the internal routing and perform other functions described herein. The network switch 500 may be configured to maximize a portion of packet-processing performed on the line cards 506a-f. The packets then travel between line-cards via the switch fabric 503. The processor 504 and data storage 505 may be used in cases where the network switch 500 exceeds capacity for processing, or storing data, on the line cards 506a-f. The data storage 505 may store the tables for routing and link state information and tables of the correspondence information described above.

Each of the line cards 505a-f may include multiple ports and port capacities. Each of the line cards 506a-f is connected to the chassis 503. The line cards 506a-f may be pluggable line cards that can be plugged into the chassis 503. The chassis 503 may include a plurality of slots (not shown), wherein line-cards 506a-f may be inserted as required. For instance, the network switch 500 may have between 4 and 9 slots for inserting line cards as is known for switches deployed in data centers or as network edges. In other instances, the line cards 506a-f are non-pluggable and integrated in the network switch 500. In yet another example, the line cards are not used and the processor 504 handles the internal routing between ports. The processor 504 may include an integrated circuit that can perform the routing and other protocol functions described herein.

The processor 504 may execute machine readable instructions 511 which are stored in a non-transitory computer readable medium, which may be included in data storage 505. The machine readable instructions 511 may include a routing module 508, correspondence determination module 509, and a remote port mirroring module 510. The remote port mirroring module 510 may generate mirroring messages as described with respect to FIGS. 3 and 4 and perform other mirroring functions as described herein.

### 4. Method

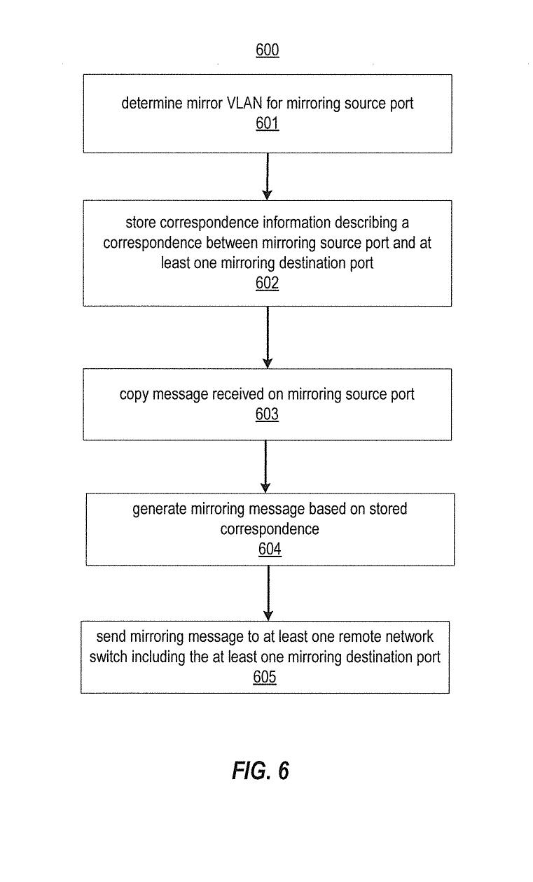

FIG. 6 illustrates a method 600 for remote port mirroring according to an example. The method 600 may be performed by a source network switch, such as network switch 3 (e.g., RB 3) shown in FIGS. 1-4. At 601, a mirror VLAN for mirroring source port P1 is determined. P1 for example is assigned to a VLAN, which is referred to the mirror VLAN. The mirror VLAN ID is stored in the network switch 1 and can be retrieved to determine the mirror VLAN for P1. The at least one mirroring destination port, such as P5 and/or P6, is assigned to the same mirror VLAN. For example, a network administrator or a configuration system can configure the VLANs for the mirroring source port and the mirroring destination port to be the same VLAN.

At 602, correspondence information describing a correspondence between the mirroring source port and the at least one mirroring destination port is stored at the source network switch. Examples of the correspondence information stored in RB 3 are shown in FIGS. 1 and 2. The correspondence information may include a VLAN ID of the mirror VLAN and an identifier (e.g., nickname) of each remote network switch having a mirroring destination port corresponding to the mirroring source port. A corresponding mirroring destination port is a destination port assigned to receive mirroring messages from a particular mirroring source port, and may be connected to a data monitoring device.

At 603, a message received on the mirroring source port is copied. The message may be from or to S1. At 604, a mirroring message is generated based on the stored correspondence information and includes the copied message and the mirror VLAN ID. At 605, the mirroring message is sent to the at least one remote network switch including the at least one mirroring destination port. The mirroring message may be unicasted if there is a single corresponding mirroring destination port or may be multicasted if there are multiple corresponding mirroring destination ports.

While the embodiments have been described with reference to examples, various modifications to the described embodiments may be made without departing from the scope of the claimed features.

What is claimed is:

1. A network switch to execute remote port mirroring comprising:
ports to send and receive messages in a network, wherein the ports include a mirroring source port;
a data storage to store correspondence information describing a correspondence between the mirroring source port and at least one mirroring destination port in at least one remote network switch in the network, wherein the correspondence information includes a VLAN ID of a mirror VLAN and an identifier of the at least one remote network switch, wherein the mirroring source port and the at least one mirroring destination port are assigned to the mirror VLAN; and
a processor to
copy a message received on the mirroring source port,
generate a mirroring message including the copied message and the mirror VLAN ID based on the stored correspondence information, and
send the mirroring message via one of the ports to the at least one remote network switch through the network.

2. The network switch of claim 1, wherein the processor is to:
send a request, including the mirror VLAN ID, via one of the plurality of ports to identify any network switch in the network with a mirroring destination port corresponding to the mirroring source port, wherein the at least one remote network switch is to receive the request and determine whether the request includes the mirror VLAN ID, and in response to the request including the mirror VLAN ID, transmit a response to the network switch including the identifier for the at least one remote network switch,
receive the response from the at least one remote network switch, and
store the correspondence information, including the identifier for the at least one remote network switch, in the data storage.

3. The network switch of claim 2, wherein to generate the mirroring message, the processor is to:
perform a lookup in a table stored in the data storage using the mirror VLAN ID, wherein the table includes the correspondence information;
identify the identifier of the at least one remote network switch from the lookup; and
generate the mirroring message from the lookup, wherein the mirroring message includes the identifier of the at least one remote network switch.

4. The network switch of claim 1, wherein the network is a Transparent Interconnection of Lots of Links (TRILL) network, and the network switch and the at least one remote network switch are routing bridges in the TRILL network.

5. A TRILL routing bridge to execute remote port mirroring comprising:
ports to send and receive messages in a network, wherein the ports include a mirroring source port;
a data storage to store correspondence information describing a correspondence between the mirroring source port and at least one mirroring destination port in at least one remote routing bridge, wherein the correspondence information includes a VLAN ID of a mirror VLAN and a nickname of the at least one remote routing bridge, wherein the mirroring source port and the at least one mirroring destination port are assigned to the mirror VLAN; and
a processor to
copy a message received on the mirroring source port,
generate a mirroring message, including the copied message, the mirror VLAN ID, and the nickname of the at least one remote routing bridge, based on the stored correspondence information, and
send the mirroring message via one of the ports to the at least one remote network routing bridge through the network.

6. A method of remote port mirroring in a network, the method comprising:
determining a mirror virtual local area network (VLAN) for a mirroring source port of a source network switch, wherein at least one mirroring destination port corresponding to the mirroring source port is assigned to the mirror VLAN, and the at least one mirroring destination port is in at least one remote network switch;
storing correspondence information describing a correspondence between the mirroring source port and the at least one mirroring destination port, wherein the correspondence information includes a VLAN ID of the mirror VLAN and an identifier of the at least one remote network switch;
copying a message received on the mirroring source port;
generating a mirroring message including the copied message and the mirror VLAN ID based on the stored correspondence information; and
sending the mirroring message to the at least one mirroring remote network switch, wherein the mirroring message is unicasted or multicasted to the remote network switch via the network.

7. The method of claim 6, comprising:
the source network switch sending a request, including the mirror VLAN ID, to identify any network switch in the network with a mirroring destination port corresponding to the mirroring source port, wherein the at least one remote network switch receives the request and determines whether the request includes the mirror VLAN ID, and in response to the request including the mirror VLAN ID, transmits a response, including the identifier for the at least one remote network switch, to the source network switch;
receiving the response from the at least one remote network switch; and
the storing of the correspondence information comprises including the identifier for the at least one remote network switch in the correspondence information.

8. The method of claim 7, wherein the generating of the mirroring message comprises:
performing a lookup in a table stored in the source network switch using the mirror VLAN ID, wherein the table includes the correspondence information;
identifying the identifier of the at least one remote network switch from the lookup; and
generating the mirroring message from the lookup, wherein the mirroring message includes the identifier of the at least one remote network switch.

9. The method of claim 8, wherein the network is a Transparent Interconnection of Lots of Links (TRILL) network, and the source network switch and the at least one remote network switch are routing bridges and the identifier is a nickname.

10. The method of claim 9, wherein the generating of the mirroring message comprises:
encapsulating the message in a TRILL message to generate the mirroring message, wherein the TRILL message includes a TRILL header including nicknames of ingress and egress routing bridges representing the source network switch and the at least one remote network switch, and an outerlayer layer 3 header.

11. The method of claim 10, wherein the at least one remote network switch is only one remote network switch, and the TRILL message is unicasted to the egress routing bridge using the TRILL header and the outerlayer header.

12. The method of claim 11, wherein the one remote network switch de-encapsulates the TRILL message to determine the copied message, and sends the copied message to a data monitoring device via the mirroring destination port.

13. The method of claim 9, wherein the generating of the mirroring message comprises:
determining whether a plurality of routing bridges are identified from the lookup;
in response to identifying the plurality of routing bridges, determining a forwarding routing bridge for a multicast distribution tree; and
encapsulating the message in a TRILL message to generate the mirroring message, wherein the TRILL message includes a TRILL header including nicknames of ingress and egress routing bridges representing the source network switch and the forwarding routing bridge, and an outerlayer layer 3 header; and
the sending of the mirroring message comprises sending the TRILL message to the forwarding routing bridge to multicast the mirroring message, wherein the forwarding routing bridge generates a new TRILL message for each of the identified plurality of routing bridges and transmits the new TRILL messages to the plurality of routing bridges through the multicast distribution tree.

14. The method of claim 13, wherein each of the identified plurality of routing bridges receives one of the new TRILL messages, de-encapsulates the received new TRILL message to determine the copied message, and sends the copied message to a data monitoring device via the mirroring destination port.

15. The method of claim 6, comprising:
creating a source mirroring group on the network switch, wherein the source mirroring group includes the mirroring source port, and the mirroring source port is connected to a computer system sending and receiving packets via the mirroring source port; and
creating at least one destination mirroring group for the at least one remote network switch, wherein the at least one destination mirroring group includes the mirroring destination port connected to a data monitoring device to monitor packets received at the mirroring source port.
